(19) United States
(12) Patent Application Publication
(10) Pub. No.: US 2015/0188838 A1
(43) Pub. Date: Jul. 2, 2015

(54) Disabling Network Connectivity on Student Devices

(71) Applicant: Texas Instruments Incorporated, Dallas, TX (US)

(72) Inventors: Rishi Bhattacharya, Del Mar, CA (US); Harshal S. Chhaya, Plano, TX (US)

(21) Appl. No.: 14/144,274

(22) Filed: Dec. 30, 2013

(51) Int. Cl. H04L 12/911; G09B 5/00

(52) U.S. Cl. CPC H04L 47/70; G09B 5/00

(57) ABSTRACT

In a classroom, students may bring their own electronic devices and use them to augment classroom instruction by connecting to a classroom network and interacting with various network resources. During certain periods of time, such as testing or pop quizzes, a teacher may assure that students do not cheat by accessing network resources by sending a command to each student device to block access to the classroom network. At the end of the time period, a command may be provided to allow the student devices to again access the network.

### BACKGROUND OF THE INVENTION

1. Field of the Invention

Embodiments of the present invention generally relate to disabling network connectivity of student owned devices while an exam is ongoing.

2. Description of the Related Art

With ever increasing frequency, school classrooms are equipped with a classroom learning system in which digital devices, e.g., handheld calculators, for student use are connected via a network to a host computer used by the teacher. Such a classroom learning system allows a teacher to perform actions such as creating and managing lessons, transferring files between the computer and the digital devices, monitoring student activity on the digital devices using screen captures, polling, assessments, etc., and performing various interactive activities with the students. Various tools are also provided for creating, distributing, and analyzing educational content. The TI-Nspire™ Navigator™ System from Texas Instruments, Inc. is an example of such a classroom learning system.

In addition to calculator based networks, schools are now embarking on BYOD (Bring Your Own Device) initiatives. In various schools, students are using various computing devices other than calculators that they own, such as: tablets, iPads, laptops, smart phones, etc, for example.

### SUMMARY

Embodiments of the present invention relate to methods and systems to disable network connectivity on student devices. In a classroom, students may bring their own electronic devices and use them to augment classroom instruction by connecting to a classroom network and interacting with various network resources. During certain periods of time, such as during testing or pop quizzes, a teacher may send a command to each student device to block access to the classroom network to assure that students do not cheat by accessing network resources. At the end of the time period, a command may be provided to allow the student devices to again access the network.

### BRIEF DESCRIPTION OF THE DRAWINGS

Particular embodiments in accordance with the invention will now be described, by way of example, and with reference to the accompanying drawings:

FIG. 1 shows an example of a classroom network;

FIGS. 2-3 illustrate an example student device that is equipped with a network interface for use in the classroom of FIG. 1;

FIG. 4 is a block diagram of a classroom network architecture;

FIG. 5 illustrates an example student device that is equipped with a secondary control network interface; and

FIG. 6 is a flow diagram of a method for disabling network connectivity on student devices in the classroom network of FIG. 1.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As technology proliferates in schools, it is important to ensure that it cannot be used to cheat during exams and other teacher-specified instances such as pop quizzes. Students are beginning to use many different BYODs (Bring Your Own Device), such as: calculators, tablets, iPads, laptops, smart phones, etc, for example. Many school campuses have now been upgraded to provide a network infrastructure that allows students to connect their device(s) and thereby interact with teachers and other students as well as access resources on the world wide web.

The TI-Nspire™ software may be loaded onto a student's BYOD and enable users to perform the same functions on a computer system that can be performed on a TI-Nspire™ calculator, i.e., the software emulates the calculator operation. Documents generated using the TI-Nspire™ software can be used on a TI-Nspire™ calculator and vice versa. Student and teacher versions of the TI-Nspire™ software are described in “TI-nspire™ Student Software Guidebook”, Texas Instruments Incorporated, 2006-2011, and “TI-nspire™ Teacher Software Guidebook”, Texas Instruments Incorporated, 2006-2011. Use of the TI-Nspire software on an iPAD® is described in “Using the TI-Nspire App for iPad for Dummies”, 2013, which is incorporated by reference herein.

Other vendors also provide software for various types of teaching aids and learning tools that students may load onto their BYODs. Typically, these software programs may have ‘exam modes’ that may allow a teacher to limit certain functionality of these applications on laptops and tablet computers during an examination. For example, LanSchool, available from Stoneware, Inc. provides a blank screen mode, a web limiting mode, and an application limiting mode, as described in more detail in “LanSchool User Guide”, v7.7, which is incorporated by reference herein. However, wireless connectivity is still maintained, which may allow enterprising students to still access remote resources during an examination.

Embodiments of the invention provide a way for a teacher to disable wireless technology in student devices during exams. Two options for doing this will be described herein: using a timer-based system where the teacher can disable network access for a pre-determined amount of time; or using a secondary communications channel to control when the primary network access needs to be enabled or disabled.

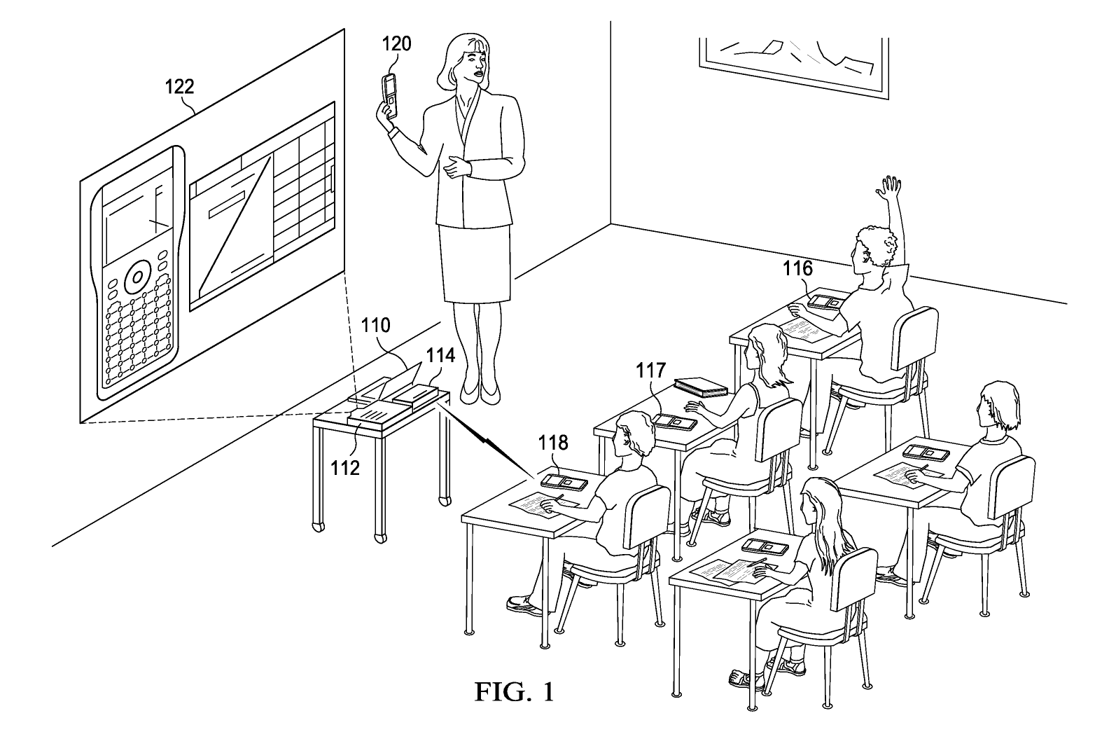

FIG. 1 shows a diagram of a classroom network configured to allow a teacher to disable network connectivity on student devices during exam time periods, for example. As shown in FIG. 1, the classroom network may include a computer system 110 communicatively coupled to a projector 112 (e.g., a digital projector), which may project images and video provided by the computer system 110 onto a wall, screen, or other surface. Computer system 110 may include presentation software (not shown) for managing the presentation of screen content received from a student BYOD as the device is operated. The presentation may be made using a display device in the computer system 110, or using a combination of the display device and the projector 112. The computer system 110 may be any general purpose computing device, such as a desktop computer, a mini-computer, a main frame, a laptop computer, a netbook, a tablet computer, or the like.

The computer system 110 may also be communicatively coupled to an access point 114 via a Universal Serial Bus (USB) connection, for example. The access point 114 provides a wireless interface such as 802.11b, 802.11g, or the like for the computer system 110 to communicate with one or more student devices 116-118. Once connected, bi-directional communications may be performed between the student devices and the computer system 110 via the access point 114. The computer system 110 and the access point 114 are illustrated as separate components for illustrative purposes only. In some embodiments, the access point 114 may be integrated into the computer system 110. Further, the coupling between the access point 114 and the computer system 110 may be any suitable wired or wireless connection. The combination of the computer system 110 and the access point 114 may be the network host for the classroom network.

In other embodiments, there may be a larger building network provided that provides wireless or wired network service to multiple classrooms using known network technology, such as a wired local area internet (LAN) backbone with multiple wireless routers for connecting to individual student BYODs, for example. A large building or campus of buildings may have multiple LANs all coupled to a wide area network (WAN) and may be coupled to larger world wide web (WWW). A network may also be implemented using cellular telephony and data networks and may include macro cells located within the building and/or class room, for example. In these embodiments, the teacher's computer system 110 may communicate with the student devices 116-118 using standard or proprietary network protocols supported by the building network, for example. As used herein, the term “network” will refer to any type of network that may be deployed in a class room or accessed in a wireless or wired manner by student devices within the classroom, such as a LAN, a WAN, the WWW, a cellular network, etc, for example.

The student devices 116-118 may be any suitable computer device, such as: handheld calculators, such as graphing calculators in the TI-Nspire product line available from Texas Instruments, Inc., for example; tablets, iPads, laptops, smart phones, etc, for example. To allow wireless communication with the access point 114 and/or the computer system 110, a wireless transceiver may be integrated into each device 116-118 or a wireless adaptor or a wireless cradle may be externally attached via a port on one or more of the devices 116-118, for example.

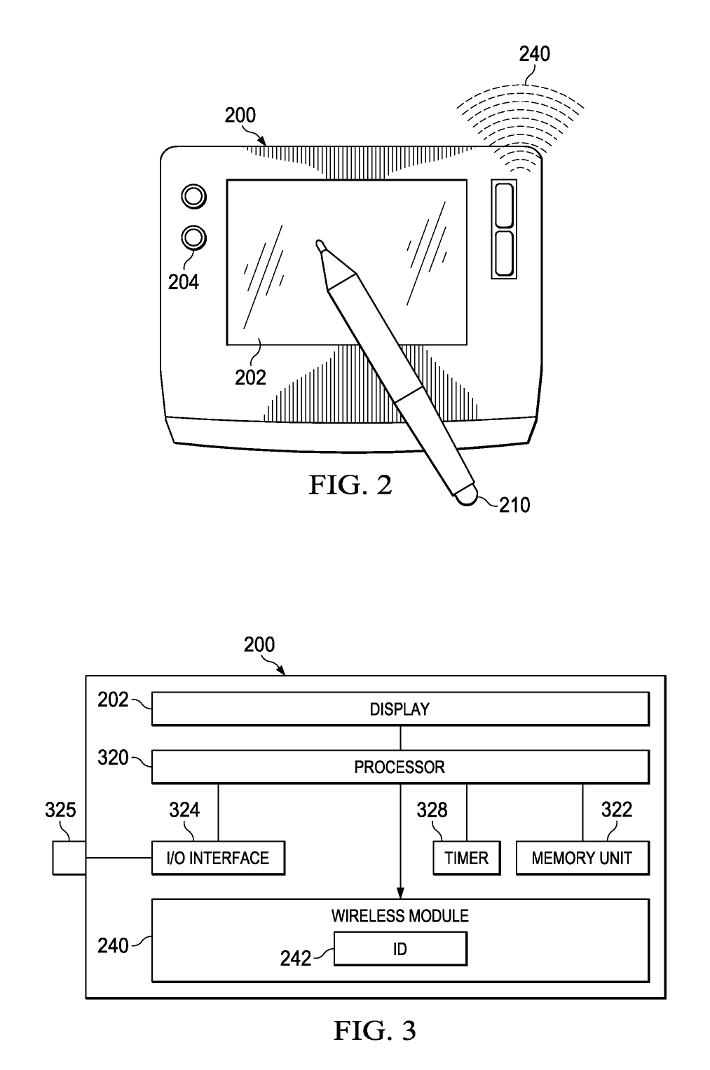

FIGS. 2 and 3 illustrate an example computer device 200 for a student in the classroom of FIG. 1 that is equipped with a network interface 240. As mentioned above, device 200 is representative of devices 116-118 and may be, for example, a calculator, a tablet computer, an iPad, a laptop computer, a smart phone, etc, for example. Devices with more or fewer components than illustrated herein may be used in embodiments of the invention.

As shown in FIG. 3, the student device may include a graphical display 202, and a keypad that may include one or more keys 204, a touchpad, etc. The graphical display 202 may be used to display, among other things, information input to applications executing on the handheld device 200 and various outputs of the applications. The graphical display 202 may be, for example, an LCD display. Display 202 may be touch sensitive and may provide a virtual keypad in place of or in addition to a physical keypad. Touch sensitive display 202 may also provide the functions of a touchpad to allow a user to input motion commands to device 200, for example. A user may interact with a touch sensitive screen 202 by using a finger or a pointing device, such as pointer 210, for example.

The virtual and/or physical keypad allows a user, e.g., a student or instructor, to enter data and functions and to start and interact with applications executing on the handheld device 200. The keypad may also include an alphabetic keyboard for entering text. A touchpad may allow a user to interact with the display by translating the motion and position of the user's fingers on the touchpad to provide functionality similar to using an external pointing device, e.g., a mouse. A user may use touch sensitive screen 202 in a similar manner to a touchpad to perform operations similar to using a pointing device on a computer system, e.g., scrolling the display 202 content, pointer positioning, selecting, highlighting, etc.

A wireless module 240 is typically included within device 200. If not, an external wireless adaptor may be communicatively coupled to device 200 by a connector, for example. Wireless module 240 may provide a wireless interface such as 802.11b, 802.11g, or the like for wireless communication with the classroom network and thereby with the computer system 110 using known or later developed techniques. A unique identification (ID) code 242 may be included within wireless module 240. ID code 242 may be the MAC (media access control) address of the wireless interface, for example. ID code 242 may be stored within a read only memory (ROM) chip, or other type of non-volatile storage device such as an electrically programmable ROM device or a flash ROM, for example to allow each student device to be uniquely identified on the network. In another embodiment, wireless module 240 with ID 242 may be configured as a cradle that provides physical support for device 200, for example.

Device 200 typically includes a processor 320 coupled to a memory unit 322, which may include one or both of read-only memory (ROM) and random-access memory (RAM). In some embodiments, the ROM stores software programs and the RAM stores intermediate data and operating results. An input/output port 325 may provide connectivity to external devices, e.g., a wireless adaptor or wireless cradle, for example. In one or more embodiments, the input/output port 325 is a bi-directional connection such as a mini-A USB port. Also included in the handheld device 200 is a display 202, as described in more detail above, and an I/O interface 324. The I/O interface 324 provides an interface to couple input devices such as a touchpad and a keypad 204 to the processor 320. In some embodiments, the handheld device 200 may also include an integrated wireless interface 240, as described in more detail above. In one or more embodiments, the memory unit 322 stores software instructions to be executed by the processor 320 to implement some or all of the device based operations of network control methods described herein. In various embodiments, a timer function 328 may be provided that is accessible for use by application software being executed by processor 320. Timer function 328 may be implemented as a hardware based timer logic module, for example, or may be implemented as a software based timer logic module that may keep track of time periods based on periodic interrupt events provided by a system clock circuit, for example.

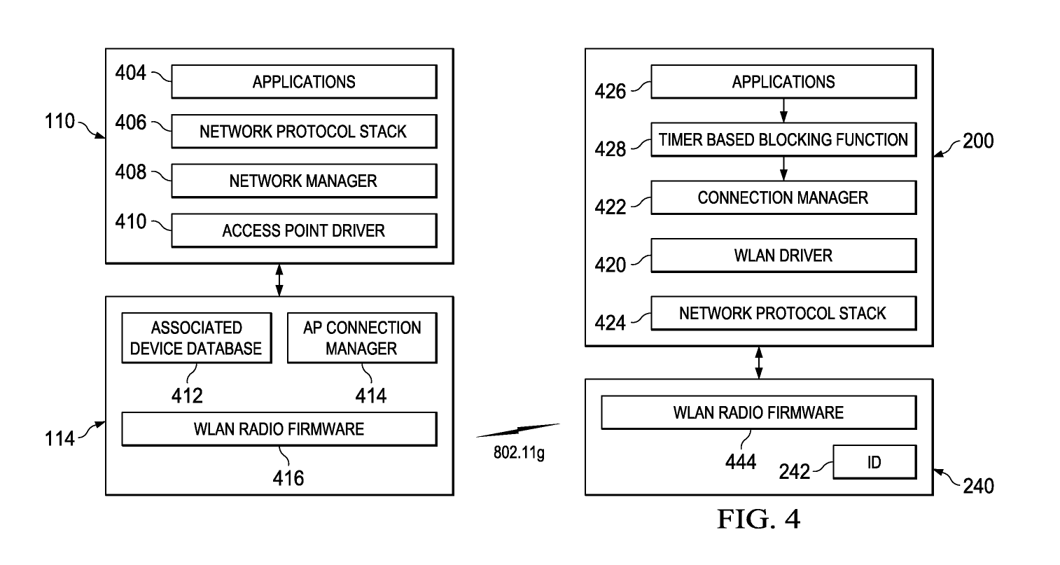

FIG. 4 is a block diagram of a classroom network communication architecture that may be used in the classroom of FIG. 1. The communication architecture includes the teacher's system, i.e., the computer 110 and the access point 114, and a representative BYOD 200 coupled to the network via a wireless adaptor 240. As discussed above, BYOD device 200 is representative of the multiple and various types of student devices 116-118. The computer 110 includes an access point driver 410, a network protocol stack 406, a network manager 408, and various applications 404. Other functionality may also be present. The access point driver 410 provides functionality for bidirectional communication with the access point 114. Such communication may include control commands and other information from the applications 404 to be sent to the calculator 118 and the receipt of responses to the commands and other information from the multiple devices 200 that may be connected to the network.

The network protocol stack 406 implements the network protocol suite of the classroom network on the computer 110. The network protocol stack 406 provides network communication services for the applications 404 and the network manager 408. The network protocol stack 406 may provide standard networking protocols such as transmission control protocol (TCP), user datagram protocol (UDP), internet protocol (IP) or custom protocols or a combination thereof, for example.

The applications 404 provide classroom management functionality as well as capabilities to create documents, transfer them to connected student devices, collect documents from the student devices, and to automatically grade student work. The applications 404 may also include features that allow the teacher to create and manage a classroom roster and a student portfolio. The applications may also allow the teacher to view all of the connected devices and monitor student progress. The functionality described above may be in one application or spread across multiple applications.

The network manager 408 provides functionality for a network administrator to manage the network. For example, the network manager 408 includes a user interface that allows the network administrator to designate the operation mode of the network. The network manager 408 may also include a user interface for presenting identification information of handheld calculators requesting association with the network and for allowing the network administrator to designate which student devices to accept and which to reject. The network manager 408 may also include a user interface that allows the network administrator to edit the associated device database 412 to add and remove associated student devices.

The access point 114 includes an access point (AP) connection manager 414, an associated device database 412, and wireless local area network (WLAN) radio firmware 416. Other functionality may also be included. The WLAN radio firmware 416 provides wireless routing functionality between the access point 114 and the device 200. The AP connection manager 414 includes functionality to manage the connection activity between the network host and the calculators, e.g., calculator 118, using the unique ID code 442, as will be described in more detail below.

During network operation, each student device 200 may request to connect to the classroom network. A network access point router, which as discussed above may be local access point 114 or it may be part of the classroom building network infrastructure, may cause the service set identifier (SSID) for the classroom network to be broadcast. In order to simplify the following description, it will be assumed that local access point 114 manages the classroom network; however, when a larger building network is provided, the control of the network may actually occur at another site remote from the teacher's computer 110. In either case, the teacher's computer may be provided with the identity of all devices that are connected to the network within the classroom. The AP connection manager then controls which calculators are allowed to join the network based on the authentication information in an associated database such as device database 412. The user of each device 200 may be required to provide a previously agreed upon password, for example. That is, the AP connection manager 414 receives requests to join the network from devices responsive to the SSID, validates the authentication information provided by the devices against authentication information in the associated device database 412, and allows those devices with validated authentication information to join the network. Any devices with authentication information that does not appear in the associated device database 412 may not allowed to join.

The associated device database 412 and associated software may be stored in any suitable storage device that is accessible to the network manager application 408.

On the student device, the wireless adaptor 240 includes WLAN radio firmware 444 and ID code 242, as described earlier. The wireless adaptor 240 may also include other functionality. The WLAN radio firmware 444 provides routing functionality between the device 200 and the access point 114.

The representative device 200 includes a WLAN driver 420, a network protocol stack 424, a connection manager 422, and various applications 426. The applications 426 provide the primary functionality of the student device. The application functionality may include but is not limited to basic calculations, function graphing, geometry, and statistical analysis, for example for a calculator type application. The WLAN driver 420 provides a software interface to the wireless modem 240 and wireless firmware 444. The driver may allow the other software modules to configure the wireless radio firmware 444. Examples of configurable parameters may include the security protocol and radio channel, for example.

The network protocol stack 424 implements the network protocol suite of the classroom network on the device 200. The network protocol stack 424 provides network communication services for the applications 426 and the connection manager 422. The network protocol stack 424 may provide standard networking protocols like TCP, UDP, and IP, or custom protocols or a combination thereof, for example.

The connection manager 422 includes functionality to manage connection activity between the device 200 and the network host system. That is, the connection manager 422 receives network SSIDs from the wireless adaptor 240 and operates the connection activity of the device 200.

An embodiment of the invention may utilize timer logic 328, referring back to FIG. 3, to implement a timer based network access blocking function 428. A network control application may be downloaded into the application set 426 as part of one or more learning tools that are loaded on student device 200. The network control application allows a teacher to send a message via the network to all student devices that are connected to the classroom network that contains a command to block further access to the network for a period of time. The teacher may want to send such a command when a test is being administered to the students in order to prevent a student from accessing reference material from the network. This allows the teacher to ensure that a student BYOD cannot be used to cheat during exams and other teacher-specified instances such as pop quizzes. Each block command may include a time amount that is specified by the teacher. Alternatively, each block command may initiate a preselected time period for blocking network access and longer blocking periods may be provided by sending additional block commands, for example.

In either case, when a block command is received from the teacher by device 200, the network control application may send control commands to connection manager 422 to cause all access to the classroom network to be blocked. At the completion of the time period, the network control application may then send control commands to connection manager 422 to again allow access to the classroom network. In this embodiment, the expiration of the specified time period generates an unblock command that allows network connectivity to be restored.

In this manner, the teacher may use the classroom network to send a ‘disable for X minutes’ command to the student devices. The classroom management software on the student devices would then disable the primary communications for the specified time. The network access would be enabled automatically after the specified time has passed. This allows the students to use any computing device (laptop, tablet, graphing calculator) regardless of its communication capabilities. Using the approach described herein, the teacher or proctor may limit the communication functionality of the client device and ensure a fair test.

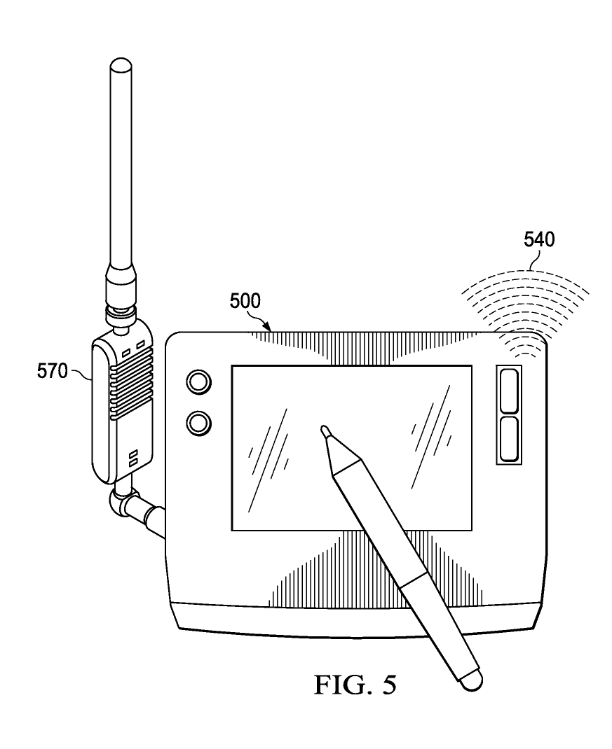

FIG. 5 illustrates an example device 500 for a student in the classroom of FIG. 1 that is equipped with a secondary control network interface 570 in addition to primary network interface 540. Device 500 may be the same as device 200, with the addition of control interface 570. Control interface 570 may be connected via port 325, referring back to FIG. 3, for example. In this embodiment, a secondary, backup communications channel (wired or wireless) is used to control the primary communications option. The teacher may use this ‘control’ network to enable or disable the communication capability of the student devices. This secondary network may have a dedicated purpose and may not be usable for regular communications. Therefore, the students would not be able to use this control network to communicate with each other or with the larger school network.

In this embodiment, the teacher may use the control network to send a block command to the student devices. When a block command is received from the teacher by device 500, the network control application may send control commands to connection manager 422, referring again to FIG. 4, to cause all access to the classroom network to be blocked. At the later time, the teacher may then send an unblock command to the student devices via the secondary control network. When the unblock command is received from the teacher via the secondary control network by device 500, the network control application may send control commands to connection manager 422 to again allow access to the classroom network.

The student devices may have a secondary network interface built-in or the school or testing agency may provide special network adapters for the student devices that implement this communications path. These adapters may use something like Zigbee or a proprietary protocol to control access to the primary wireless network. The latest ZigBee specification, officially named ZigBee 2012, offers full wireless mesh networking capable of supporting more than 64,000 devices on a single network. ZigBee is a specification for a suite of high level communication protocols used to create personal area networks built from small, low-power digital radios. ZigBee is based on an IEEE 802.15 standard. Though low-powered, ZigBee devices can transmit data over long distances by passing data through intermediate devices to reach more distant ones, creating a mesh network. For example, each secondary interface 570 may receive and rebroadcast network traffic to form a network with no centralized control or high-power transmitter but able to reach all of the networked devices.

ZigBee is used in applications that require only a low data rate, long battery life, and secure networking. ZigBee has a defined rate of 250 kbit/s, best suited for periodic or intermittent data or a single signal transmission from a sensor or input device. Typical applications include wireless light switches, electrical meters with in-home-displays, traffic management systems, and other consumer and industrial equipment that requires short-range wireless transfer of data at relatively low rates. This assures that it cannot be used for access by the student device. Other embodiments may use other options for the control network, such as Bluetooth, optical networks, wired networks, etc., for example.

In this manner, the teacher may use the secondary control network to send a block command to the student devices. The classroom management software on the student devices would then disable the primary communication network. At a later time, the teacher may send an unblock command via the secondary control network to the student device. This allows the students to use any computing device (laptop, tablet, graphing calculator) that is fitted with both a primary and a secondary communication capability. The teacher may also use this secondary network to monitor student progress throughout the exam, for example.

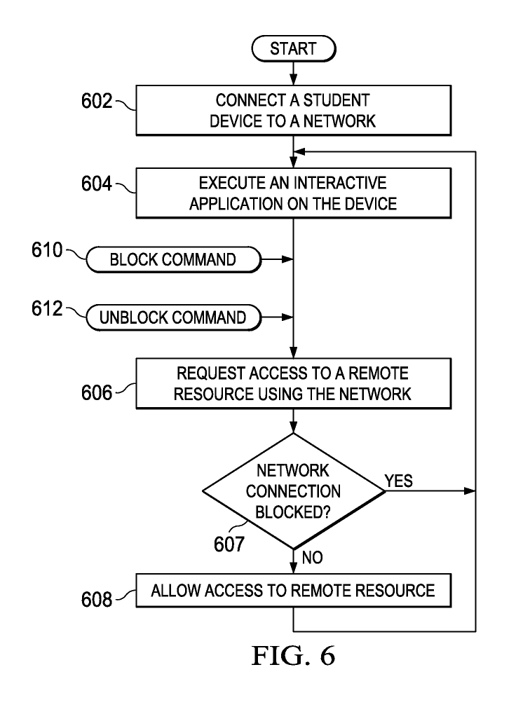

FIG. 6 is a flow diagram of a method for disabling network connectivity on student devices in the classroom network of FIG. 1. Initially, the student devices connect 602 to the classroom network, as described in more detail above. The connection process may involve and exchange of data to verify that a student device is allowed to be connected to the network, for example.

While the student device is connected to the network, one or more interactive applications may be executed 604 on the device. These may be various learning tools that allow the students and teacher to interact by accessing 606-608 remote resources, as described in more detail above. The student device may request access 606 to one or more remote resources using the network. As long as the network connection on the student device is not blocked 607, the student device will be able to access 608 the requested remote resources in the normal manner.

When the teacher is ready to administer a test or pop quiz, the teacher may send a block command 610 to all of the student devices in the classroom. When a block command is received from the teacher by a student device, a network control application within the each student device may send control commands to a connection manager within the student device to cause all access to the classroom network to be blocked 607. While network access is blocked, the student device may attempt to access 606 a remote resource; however, while the network connection is blocked, the student device will be prevented from accessing 608 any remote resources. While network access is blocked, the student device may continue to execute applications 604 locally on the device.

In a first embodiment, the block command may be received via the communication network and may specify an amount of time to block access to the network. In a second embodiment, the block command may be received via a secondary control network, as described in more detail above.

At a later time, an unblock command 612 may be received by each student device. When an block command 612 is received from the teacher by a student device, a network control application within the each student device may send control commands to a connection manager to cause access to the classroom network to be restored 606. In the first embodiment, the unblock command may be simply the result of the completion of a time period specified either directly or impliedly by the block command. In the second embodiment, the unblock command may be received via the secondary control network.

Depending on the capabilities of the student device and the existence of network “hotspots” in the vicinity of the student device, a student may connect 602 the student device to more than one network. For example, a student may connect to the classroom network and also to other wireless networks within range of the student device, or to a cellular based network, for example. By disabling the network controller on the student device in response to receiving a block command 610, the student device will be prevented from accessing any network while the block command is in effect.

In this manner, the teacher or proctor may limit the communication functionality of the client device and ensure a fair test. This allows the students to use any computing device (laptop, tablet, graphing calculator) and still have network access controlled by the teacher.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, embodiments are discussed described in which the digital devices in the classroom network may be handheld calculators. It should be noted, however, that other types of digital devices, e.g., laptop computers, desktop computers, tablet computers, and handheld computing devices may be used. Examples of other types of handheld computing devices include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for operating a student device in a classroom network, the method comprising:
connecting the student device to a classroom network using a network interface on the student device;
disabling access to any network via the network interface by disabling the network interface on the student device in response to receiving a block command from an external source; and
enabling access to the classroom network by enabling the network interface on the student device in response to receiving an unblock command.

2. The method of claim 1, further comprising:
executing one or more applications on the student device that allow a student to interact with the student device;
accessing remote resources by an application on the student device using the classroom network while the network interface is enabled; and
allowing the student to interact with the one or more applications on the student device in a local manner while the network interface is disabled.

3. The method of claim 1, wherein the block command and the unblock command are received via an auxiliary interface on the student device connected to an auxiliary control network.

4. The method of claim 3, wherein the auxiliary control network is a Zigbee network.

5. The method claim 1, wherein the block command is received via the classroom network, further comprising:
starting a timer function in the student device in response to receiving the block command; and
receiving the unblock command from the timer function after a designated period of time.

6. The method of claim 5, wherein the block command includes a time value for the designated period of time.

7. The method of claim 5, wherein the designated period of time is a predefined amount.

8. A student device for use in a classroom, the device comprising:
a display screen and storage memory coupled to a processor operable to execute software instructions stored in the memory;
a network interface coupled to the processor operable to communicate with a network; and
wherein by executing the software instructions, the processor is operable to perform a method comprising:
connecting the student device to a classroom network using the network interface on the student device;
disabling access to any network via the network interface by disabling the network interface on the student device in response to receiving a block command from an external source; and
enabling access to the classroom network by the student device by enabling the network interface in response to receiving an unblock command.

9. The device of claim 8, further comprising:
executing one or more applications on the student device that allow a student to interact with the student device;
accessing remote resources by an application on the student device using the classroom network while the network interface is enabled; and
allowing the student to interact with the one or more applications on the student device in a local manner while the network interface is disabled.

10. The device of claim 9, further comprising a secondary network interface coupled to the processor, wherein the block command and the unblock command are received from a control network via the secondary network interface.

11. The device of claim 10, wherein the control network is a Zigbee network.

12. The device of claim 9, further comprising a timer function coupled to the processor, wherein the block command is received via the network, further comprising:
starting a timer function in the student device in response to receiving the block command; and
receiving the unblock command responsive to the timer function after a designated period of time.

13. The device of claim 12, wherein the block command includes a time value for the designated period of time.

14. The device of claim 12, wherein the designated period of time is a predefined amount.

15. A non-transitory computer-readable medium storing software instructions that, when executed by a processor, perform a method for operating a student device, the method comprising:
disabling access to a network by disabling a network interface on the student device in response to receiving a block command from an external source; and
enabling access to the network by enabling the network interface on the student device in response to receiving an unblock command.

16. The method claim 15, wherein the block command is received via a classroom network, further comprising:
starting a timer function in the student device in response to receiving the block command; and
receiving the unblock command from the timer function after a designated period of time.

17. The method of claim 16, wherein the block command includes a time value for the designated period of time.

18. The method of claim 16, wherein the designated period of time is a predefined amount.

19. The method of claim 15, wherein the block command and the unblock command are received via an auxiliary interface on the student device connected to an auxiliary control network.
